(19) United States
(12) Patent Application Publication
(10) Pub. No.: US 2022/0334859 A1
(43) Pub. Date: Oct. 20, 2022

(54) PARALLELIZATION OF DISTRIBUTED WORKLOADS WITH CONSTRAINED RESOURCES USING COORDINATED THREADS

(71) Applicant: VMware, Inc., Palo Alto, CA (US)

(72) Inventors: Yiqi XU, Mountain View, CA (US); Xin LI, Fremont, CA (US); Eric KNAUFT, San Francisco, CA (US)

(21) Appl. No.: 17/231,386

(22) Filed: Apr. 15, 2021

(51) Int. Cl. G06F 9/455; G06F 9/50

(52) U.S. Cl. CPC G06F 9/45558; G06F 9/5077; G06F 9/5083; G06F 2009/45595

(57) ABSTRACT

An example method of coordinating threads executing in a host cluster in a virtualized computing system is described. The host cluster includes hosts connected to a network. The method includes: assigning objects to owner threads of an owner executing in a first host of the hosts, the objects mapped to virtual resources attached to virtual machines (VMs) executing in the host cluster; assigning components of the objects to component threads executing in a second host of the hosts based on thread indexes of the owner threads, the component threads managing physical resources backing the virtual resources; and establishing connections through the network between the owner threads and the component threads.

Applications today are deployed onto a combination of virtual machines (VMs), containers, application services, and more within a software-defined datacenter (SDDC). The SDDC includes a server virtualization layer having clusters of physical servers that are virtualized and managed by virtualization management servers. Each host includes a virtualization layer (e.g., a hypervisor) that provides a software abstraction of a physical server (e.g., central processing unit (CPU), random access memory (RAM), storage, network interface card (NIC), etc.) to the VMs. A virtual infrastructure administrator (“VI admin”) interacts with a virtualization management server to create server clusters (“host clusters”), add/remove servers (“hosts”) from host clusters, deploy/move/remove VMs on the hosts, deploy/configure networking and storage virtualized infrastructure, and the like. The virtualization management server sits on top of the server virtualization layer of the SDDC and treats host clusters as pools of compute capacity for use by applications.

A host cluster supports execution of distributed workloads. Modules of a distributed workload can execute across different hosts in the cluster and communicate with one another. Modules of a distributed workload, executing in different hosts, can use multiple network connections for parallelism and scalability. In some cases, however, a distributed workload's data hierarchy can cause the number of network connections among modules to reach resource limits. For example, an owner module in one host may require connections to component modules in each remaining host of the host cluster. Each of the owner module and the component modules may execute multiple threads for parallelization. The data hierarchy may require that all threads of the owner module have connections to all threads of each component module. If resource limits are reached, threads of the owner module may fail to connect to threads of component modules, resulting in failures. In particular, input/output (IO) failures, which prevent the workload from making the application state persistent, are some of the most severe type of failures that can result in data loss.

### BRIEF DESCRIPTION OF THE DRAWINGS

FIG. 1 is a block diagram of a virtualized computing system in which embodiments described herein may be implemented.

FIG. 2 is a block diagram depicting a software platform according an embodiment.

FIG. 3A is a block diagram depicting logical communication between a VM and a disk group through a vSAN according to an embodiment.

FIG. 3B is a block diagram showing the relationship between client, owner, and component threads in a vSAN according to an embodiment.

FIG. 4 is a block diagram depicting network connections between owner threads and component threads in a distributed storage system according to an embodiment.

FIG. 5 is a flow diagram depicting a method of initially assigning components among component threads upon host reboot according to an embodiment.

FIG. 6 is a flow diagram depicting a method of managing components and component threads based on a component-follows-owner scheme according to an embodiment.

### DETAILED DESCRIPTION

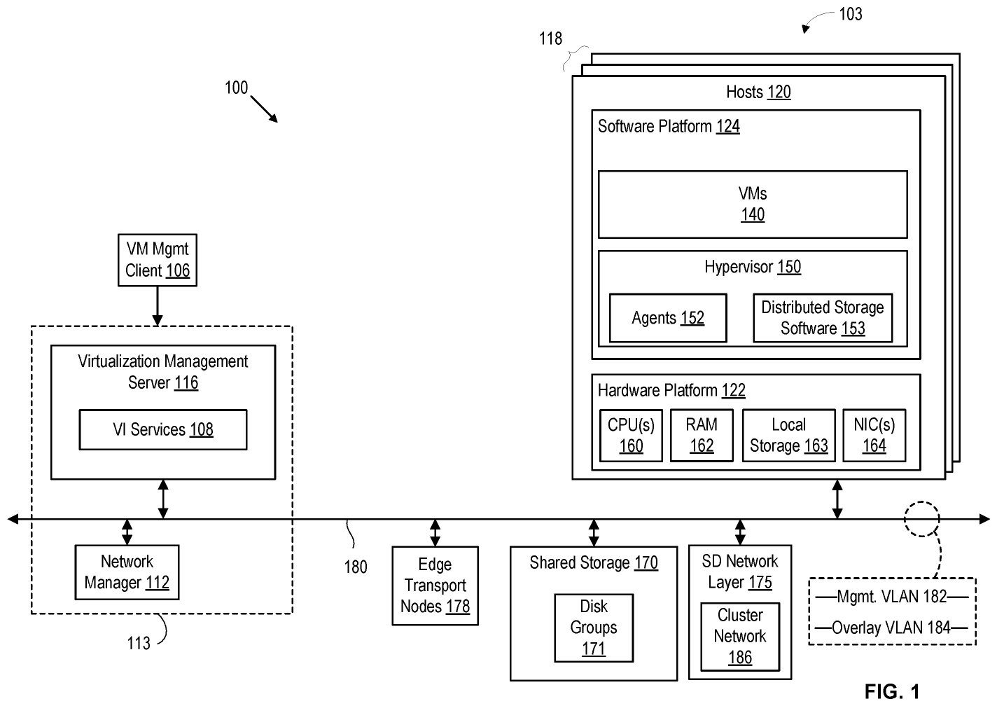

FIG. 1 is a block diagram of a virtualized computing system 100 in which embodiments described herein may be implemented. System 100 includes a cluster of hosts 120 (“host cluster 118”) that may be constructed on server-grade hardware platforms such as an x86 architecture platforms. For purposes of clarity, only one host cluster 118 is shown. However, virtualized computing system 100 can include many of such host clusters 118. As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 180. Physical network 180 enables communication between hosts 120 and between other components and hosts 120 (other components discussed further herein). Physical network 180 can include a plurality of VLANs to provide external network virtualization as described further herein.

In the embodiment illustrated in FIG. 1, hosts 120 access shared storage 170 by using NICs 164 to connect to network 180. In another embodiment, each host 120 contains a host bus adapter (HBA) through which input/output operations (IOs) are sent to shared storage 170 over a separate network (e.g., a fibre channel (FC) network). Shared storage 170 include one or more storage arrays, such as a storage area network (SAN), network attached storage (NAS), or the like. Shared storage 170 may comprise magnetic disks, solid-state disks (SSDs), flash memory, and the like as well as combinations thereof. In some embodiments, hosts 120 include local storage 163 (e.g., hard disk drives, solid-state drives, etc.). Local storage 163 in each host 120 can be aggregated and provisioned as part of a virtual SAN (vSAN), which is another form of shared storage 170. Virtualization management server 116 can select which local storage devices in hosts 120 are part of a vSAN for host cluster 118. Shared storage 170 includes disk groups 171. Each disk group 171 includes a plurality of local storage devices 163 of a host 120. Each disk group 171 can include cache tier storage (e.g., SSD storage) and capacity tier storage (e.g., SSD, magnetic disk, and the like storage).

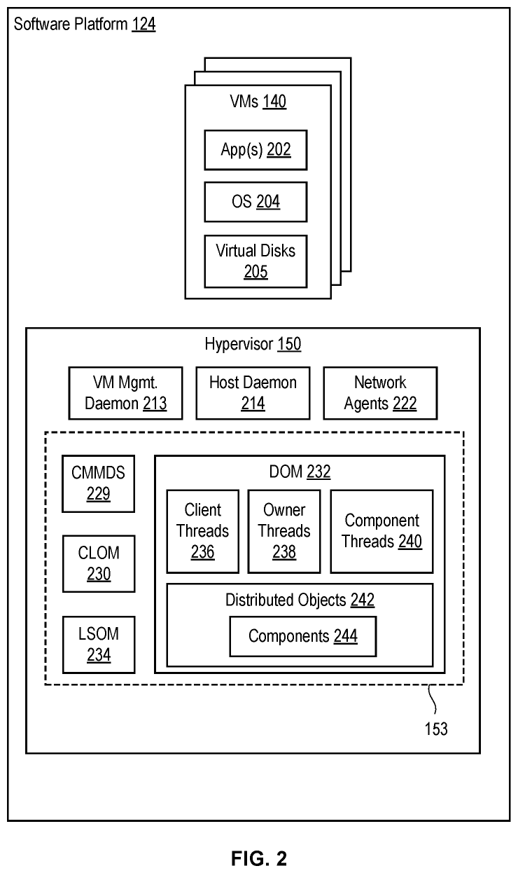

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a “bare-metal” hypervisor). As a result, the virtualization layer in host cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (VM) 140 may be concurrently instantiated and executed. One example of hypervisor 150 that may be configured and used in embodiments described herein is a VMware ESXi™ hypervisor provided as part of the VMware vSphere® solution made commercially available by VMware, Inc. of Palo Alto, Calif. An embodiment of software platform 124 is discussed further below with respect to FIG. 2.

In embodiments, host cluster 118 is configured with a software-defined (SD) network layer 175. SD network layer 175 includes logical network services executing on virtualized infrastructure in host cluster 118. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches, logical routers, logical firewalls, logical virtual private networks (VPNs), logical load balancers, and the like, implemented on top of the virtualized infrastructure. In embodiments, virtualized computing system 100 includes edge transport nodes 178 that provide an interface of host cluster 118 to an external network (e.g., a corporate network, the public Internet, etc). Edge transport nodes 178 can include a gateway between the internal logical networking of host cluster 118 and the external network. Edge transport nodes 178 can be physical servers or VMs.

Virtualization management server 116 is a physical or virtual server that manages host cluster 118 and the virtualization layer therein. Virtualization management server 116 installs agent(s) 152 in hypervisor 150 to add a host 120 as a managed entity. Virtualization management server 116 logically groups hosts 120 into host cluster 118 to provide cluster-level functions to hosts 120, such as VM migration between hosts 120 (e.g., for load balancing), distributed power management, dynamic VM placement according to affinity and anti-affinity rules, and high-availability. The number of hosts 120 in host cluster 118 may be one or many. Virtualization management server 116 can manage more than one host cluster 118.

In an embodiment, virtualized computing system 100 further includes a network manager 112. Network manager 112 is a physical or virtual server that orchestrates SD network layer 175. In an embodiment, network manager 112 comprises one or more virtual servers deployed as VMs. Network manager 112 installs additional agents 152 in hypervisor 150 to add a host 120 as a managed entity, referred to as a transport node. In this manner, host cluster 118 can be a cluster 103 of transport nodes. One example of an SD networking platform that can be configured and used in embodiments described herein as network manager 112 and SD network layer 175 is a VMware NSX® platform made commercially available by VMware, Inc. of Palo Alto, Calif.

Network manager 112 can deploy one or more transport zones in virtualized computing system 100, including VLAN transport zone(s) and an overlay transport zone. A VLAN transport zone spans a set of hosts 120 (e.g., host cluster 118) and is backed by external network virtualization of physical network 180 (e.g., a VLAN). One example VLAN transport zone uses a management VLAN 182 on physical network 180 that enables a management network connecting hosts 120 and the VI control plane (e.g., virtualization management server 116 and network manager 112). An overlay transport zone using overlay VLAN 184 on physical network 180 enables an overlay network that spans a set of hosts 120 (e.g., host cluster 118) and provides internal network virtualization using software components (e.g., the virtualization layer and services executing in VMs). Host-to-host traffic for the overlay transport zone is carried by physical network 180 on the overlay VLAN 184 using layer-2-over-layer-3 tunnels. Network manager 112 can configure SD network layer 175 to provide a cluster network 186 using the overlay network. The overlay transport zone can be extended into at least one of edge transport nodes 178 to provide ingress/egress between cluster network 186 and an external network.

Virtualization management server 116 and network manager 112 comprise a virtual infrastructure (VI) control plane 113 of virtualized computing system 100. In embodiments, network manager 112 is omitted and virtualization management server 116 handles virtual networking. Virtualization management server 116 can include VI services 108. VI services 108 include various virtualization management services, such as a distributed resource scheduler (DRS), high-availability (HA) service, single sign-on (SSO) service, virtualization management daemon, vSAN service, and the like. DRS is configured to aggregate the resources of host cluster 118 to provide resource pools and enforce resource allocation policies. DRS also provides resource management in the form of load balancing, power management, VM placement, and the like. HA service is configured to pool VMs and hosts into a monitored cluster and, in the event of a failure, restart VMs on alternate hosts in the cluster. A single host is elected as a master, which communicates with the HA service and monitors the state of protected VMs on subordinate hosts. The HA service uses admission control to ensure enough resources are reserved in the cluster for VM recovery when a host fails. SSO service comprises security token service, administration server, directory service, identity management service, and the like configured to implement an SSO platform for authenticating users. The virtualization management daemon is configured to manage objects, such as data centers, clusters, hosts, VMs, resource pools, datastores, and the like.

A VI admin can interact with virtualization management server 116 through a VM management client 106. Through VM management client 106, a VI admin commands virtualization management server 116 to form host cluster 118, configure resource pools, resource allocation policies, and other cluster-level functions, configure storage and networking, and the like.

Hypervisor 150 further includes distributed storage software 153 for implementing a vSAN on host cluster 118. Distributed storage systems include a plurality of distributed storage nodes. In the embodiment, each storage node is a host 120 of host cluster 118. In the vSAN, virtual storage used by VMs 140 (e.g., virtual disks) is mapped onto distributed objects (“objects”). Each object is a distributed construct comprising one or more components. Each component maps to a disk group 171. For example, an object for a virtual disk can include a plurality of components configured in a redundant array of independent disks (RAID) storage scheme. Input/output (I/O) requests by VMs 140 need to traverse through network 180 to reach the destination disk groups 171. In some cases, such traversal involves multiple hops in host cluster 118 and network resources (e.g., transmission control protocol/internet protocol (TCP/IP) sockets, remote direct memory access (RDMA) message pairs, and the like) are heavily consumed.

For example, in vSAN, a virtual disk maps to an object with multiple components for availability and performance purposes. An I/O request issued by a VM 140 arrives at an owner (the I/O coordinator of this object). The owner is responsible for sending additional I/Os to the RAID tree that the object's policy maintains. This RAID tree might divide the owner level I/Os into multiple smaller sub I/Os (and even multiple batches of these with barriers in-between). The owner's sub I/Os reach the destination host, where the actual data component resides (a particular disk group 171). This is the smallest granularity of an I/O destination. Since this is a distributed system, CLIENT, OWNER, and COMPONENT are role names and could or could not be on the same host, hence the network traversal is a must.

FIG. 2 is a block diagram depicting software platform 124 according an embodiment. As described above, software platform 124 of host 120 includes hypervisor 150 that supports execution of VMs 140. In an embodiment, hypervisor 150 includes a VM management daemon 213, a host daemon 214, and distributed storage software 153. VM management daemon 213 is an agent 152 installed by virtualization management server 116. VM management daemon 213 provides an interface to host daemon 214 for virtualization management server 116. Host daemon 214 is configured to create, configure, and remove VMs (e.g., pod VMs 130 and native VMs 140). Network agents 222 comprises agents 152 installed by network manager 112. Network agents 222 are configured to cooperate with network manager 112 to implement logical network services. Network agents 222 configure the respective host as a transport node in a cluster 103 of transport nodes. Each VM 140 has applications 202 running therein on top of an OS 204. Each VM 140 has one or more virtual disks 205 attached thereto for data storage and retrieval.

Distributed storage software 153 includes a cluster membership, monitoring and directory services (CMMDS) 229, a cluster-level object manager (CLOM) 230, a local log-structured object manager (LSOM) 234, and a distributed object manager (DOM) 232. CMMDS 229 provides topology and object configuration information to CLOM 230 and DOM 232. CMMDS 229 selects owners of objects, inventories items (hosts, networks, devices), stores object metadata information, among other management functions. CLOM 230 provides functionality for creating and migrating distributed objects 242 that back virtual disks 205. LSOM 234 provides functionality for interacting with local storage 163 of disk groups 171. DOM 232 is configured to receive instructions from CLOM 230, receive I/O requests from VMs 140, communicate with other DOMs in other hosts, and provide instructions to LSOM 234 for reading and writing to local storage 163. DOM 232 includes a client role, an owner role, and a component role. The client role is implemented by client threads 236, which collectively provide a client. Each host 120 in host cluster 118 includes a client comprising client threads 236. The owner role is implemented by owner threads 238, which provide owners of distributed objects 242. Each distributed object 242 includes an owner and each owner is managed by an owner thread 238. The component role is implemented by component threads 240. Each component thread controls I/O for a disk group 171. Each distributed object 242 includes one or more components 244, where each component 244 is managed by a component thread 240.

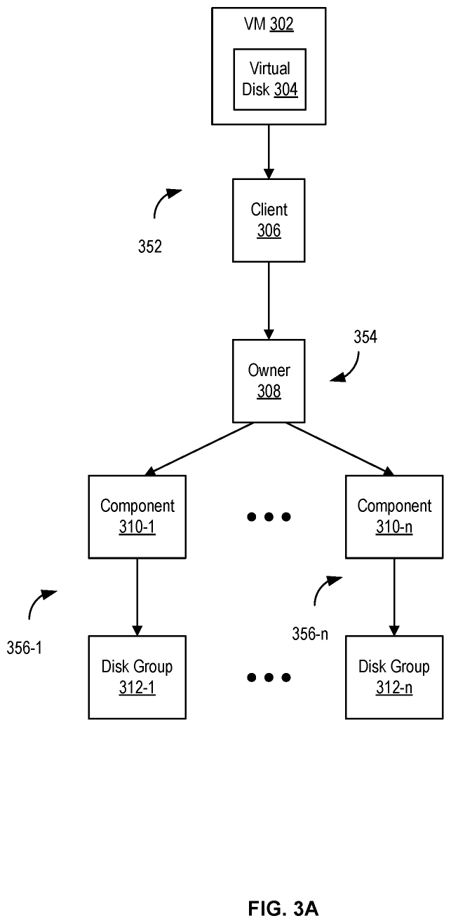

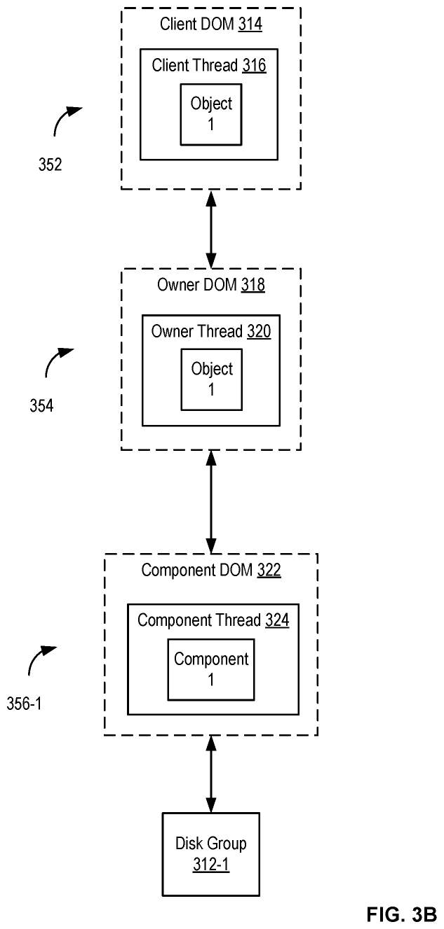

FIG. 3A is a block diagram depicting logical communication between a VM and a disk group through a vSAN according to an embodiment. A VM 302 is attached to a virtual disk 304. Virtual disk 304 is stored using a RAID scheme on capacity disks in disk groups 312-1 through 312-n (where n is an integer greater than one). VM 302 executes in a client host 352. A client 306 in client host 352 receives I/O requests from VM 302. Virtual disk 304 is mapped to an object. Client 306 forwards the I/O requests to an owner 308 of the object. Owner 308 executes on an owner host 354. The object for virtual disk 304 includes n components 310-1 . . . 310-n, one for each disk group 312-1 . . . 312-n. Disk groups 312-1 . . . 312-n are present in component hosts 356-1 . . . 356-n. Owner 308 forwards I/O requests to each component 310-1 . . . 310-n. Components 310-1 . . . 310-n execute in component hosts 356-1 . . . 356-n, respectively. Components 310-1 . . . 310-n process the I/O requests for disk groups 312-1 . . . 312-n. Note there is no assumption of locality. There are implementations considering locality of client and owner, or owner and components. However, since this is a distributed system with data duplicated on any possible fault domains, non-local access is the majority I/O patterns and is inevitable. The owner can be on a different host than the client (as shown in the example). Likewise, component(s) may be on different hosts than the owner (as shown in the example). As such, owner threads 238 in one host 120 include network connections with client threads 236 in another host 120. An owner thread 238 in one host 120 includes network connections with component threads 240 in other host(s) 120. Note that I/O requests from the client might in some cases traverse more than one owner until reaching a leaf owner. In the example, owner 308 is the leaf owner.

FIG. 3B is a block diagram showing the relationship between client, owner, and component threads in a vSAN according to an embodiment. Client 306 includes a client thread 316 of a client DOM 314. Client thread 316 is responsible for an object 1, which is mapped to virtual disk 304. Client thread 316 handles I/O requests from VM 302 that target virtual disk 304. Client thread 316 has a network connection with an owner thread 320 in an owner DOM 318 executing in owner host 354. Owner thread 320 is responsible for object 1. Owner thread 320 has network connections with component threads associated with all disk groups backing virtual disk 304. In the example of FIG. 3B, only the first disk group 312-1 is shown for simplicity. Thus, owner thread 320 includes a network connection with a component thread 324 of a component DOM 322 executing in component host 356-1. Component thread 324 is responsible for component 1, which is a component of object 1. Note that client DOM 314, owner DOM 318, and component DOM 322 are each a DOM 232 performing the respective client, owner, and component roles, respectively.

Whenever a role A communicates with another role B (e.g., owner to component), assuming they are on different hosts, a pair of sockets are needed for A and B. In a one-thread model, a socket between role A and role B can be reused and there will not be any interference between different objects or components between two hosts. However, the cost is prohibitively high: no roles can use more than one CPU at a time, and it severely limits the scalability of the vSAN system to handle a large number of objects concurrently.

In a many thread model, there are multiple threads for each of client, owner, and components (as shown in FIG. 2). The client has the heavy load of (including but not limited to) end-to-end checksum verifying, and the owner has the substantial amount work of coordinating sub I/Os and maintaining the RAID tree. In this model, each client thread 236 and each owner thread 238 is responsible for a specific subset of objects 242. In an embodiment, an object 242 is assigned to a client thread 236 and an owner thread 238 by taking a hash of a universal unique identifier (UUID) of the object modulo the number of respective threads. Likewise, each component thread 240 is responsive for a specific subset of components 244. On the component side, multiple components 244 on the same component thread 240 can belong to different objects 242. A component thread 240 is a per disk group entity, as discussed above.

In embodiments, the number of client threads 236 matches the number of owner threads 238. Thus, objects 242 are assigned to the same thread index in the array of client threads 236 and the array of owner threads 238 (based on a hash of the object UUID modulo the number of threads). However, the number of owner threads 238 may differ from the number of component threads 240. One connection scheme between owner threads 238 and component threads 240 is an all-to-all scheme. That is, each owner thread 238 includes a network connection with each component thread 240. In host cluster 118, the per-host connection number is determined by: numConn (c)=client-owner(a)+owner-comp(b), where: (a)=(hosts−1)*numOwnerThreads*2; (b)=(a)*numThreadsPerDG*numDGs; and (c)=(a)+(b). In the equation, “DG” connotes disk group 171. Assuming in an example there are 64 hosts, 21 owner threads, and two disk groups (numDGs=2). If there is one thread per disk group (numThreadsPerDG=1), then numConn is 7938 connections. However, to take advantage of parallelization, there can be more than one thread per disk group to service I/O requests. If numThreadsPerDG=2, then numConn increases to 13,230. With five disk groups (numDGs=5) and five threads per disk group (numThreadsPerDG=5), the number of connections increases to 68,796. In hypervisor 150, sockets are not an unlimited resource. For example, the number of TCP/IP sockets can be limited to 64,000. The number of RDMA connections can be limited to about 7000. As such, the all-to-all connection scheme can result in exceeding resource limits and the failure of I/O requests.

One approach to solving the above-identified connection problem is a simple mapping approach. The simple mapping approach solves the problem of uneven distribution of the role threads of the same objects. If an object belongs to thread 0 of owner threads 238, its components should also belong to thread 0 of component threads 240. This will eliminate the specific owner thread having to be connected to all component threads for each target disk group and reduces the number of sockets between the owner and component sides.

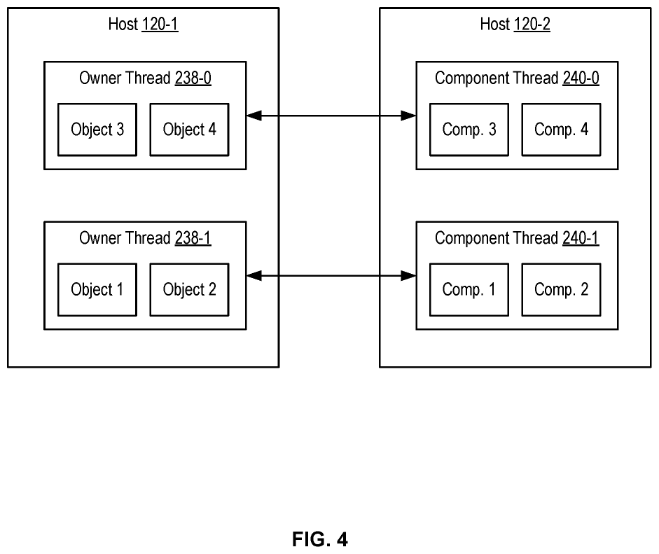

FIG. 4 is a block diagram depicting network connections between owner threads and component threads in a distributed storage system according to an embodiment. Host 120-1 includes owner threads 238-0 and 238-1. Host 120-2 includes component threads 240-0 and 240-1. Owner thread 238-0 is responsible for objects 3 and 4. Owner thread 238-1 is responsible for objects 1 and 2. Component thread 240-0 is responsible for components 3 and 4. Component thread 240-1 is responsible for components 1 and 2. Note that Comps 1 and 2 belong to Objects 1 and 2 respectively, and Comps 3 and 4 belong to Objects 3 and 4 respectively. Objects 3 and 4 need to send I/O requests to components 3 and 4, respectively. Objects 1 and 1 need to send I/O requests to components 1 and 2, respectively. In the simple mapping scheme described above, owner thread 238-0 has a connection to only component thread 240-0. Owner thread 238-1 has a connection to only component thread 240-1. No objects in owner thread 238-0 require connections to components in component thread 240-1. Likewise, no objects in owner thread 238-1 require connections to components in component thread 240-0. As the number of owner threads, disk groups, threads per disk group, and hosts increase, the simple mapping scheme results in significantly less network connections than the all-to-all mapping scheme.

The algorithm for assigning objects to owner threads can be a hash of the object UUID modulo the number of owner threads. The algorithm for assigning components to component threads can be a hash of the object UUID module the number of component threads. The number of owner threads is a multiple of the number of component threads. While the simple mapping approach works to reduce the number of connections, the approach can fail if the cluster is undergoing a rolling upgrade, where mixed versions of software exist. Different versioned software may use different algorithms and/or different numbers of threads. As a result, sockets can become exhausted similar to the all-to-all scheme, causing I/O requests to fail.

The result in FIG. 4 can also be achieved using a component-follows-owner scheme as described in embodiments herein. The component-follows-owner scheme is improved over the simple mapping scheme and is robust in the case of rolling upgrades in the host cluster. Instead of choosing a component thread based on a hash of the object UUID, the component thread is chosen based on the owner object's thread index. In this manner, one owner thread needs only one connection to one of the multiple component threads for a disk group and the total number of connections is the same as if there is only one component thread per disk group. This approach involves extra communications between the owner and component roles threads while the owner or the component data structure in the respective threads are being initialized or re-initialized. It also requires re-synchronization to keep the data consistent between components, as described below.

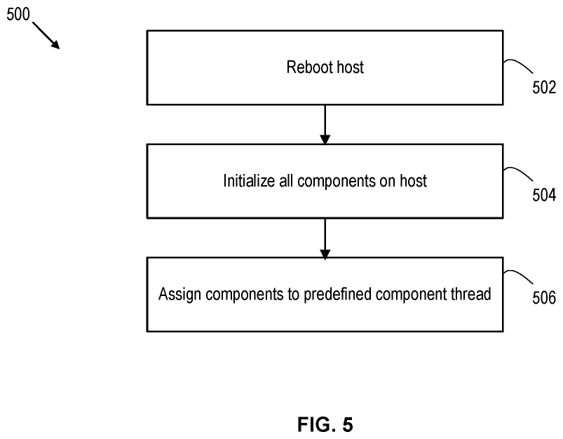

FIG. 5 is a flow diagram depicting a method 500 of initially assigning components among component threads upon host reboot according to an embodiment. Method 500 begins at step 502, where the host is rebooted. At step 504, after reboot. DOM 232 initializes all components on the host associated with a disk group. At step 506, DOM 232 assigns all components to a predefined component thread of the disk group. When the host reboots, the owner object's thread index is not available. In such case, all components can be assigned to a specific component thread (e.g., the first component thread of the disk group). In the method described below, once an object's thread index is known, components can be moved to different component threads to achieve the component-follows-owner scheme described above. Note that initial component assignment can be distributed among multiple component threads for the disk group (e.g., based on a hash of the component UUID), but this will not reduce the number of components that need to move when their owner establishes a connection. Statistically half of the components need to move, thus it is simpler to assign all components to the predefined component thread (step 406). Since at this moment the object's owner has not yet issued any I/O workloads to the components that have finished initializing, no sockets or network connections are created and exhausted above the kernel resource limit.

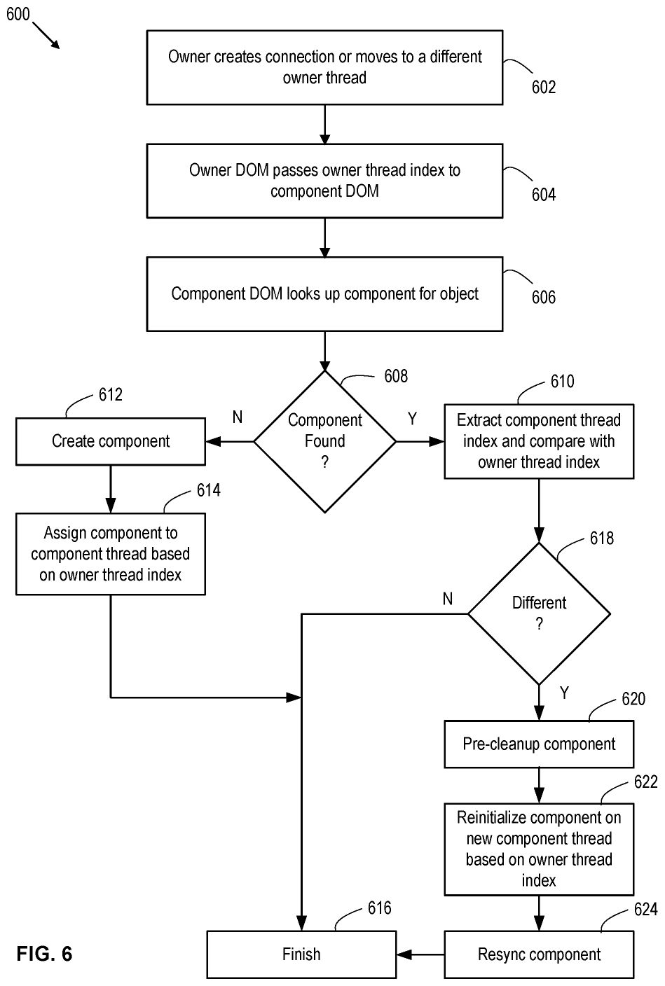

FIG. 6 is a flow diagram depicting a method 500 of managing components and component threads based on a component-follows-owner scheme according to an embodiment. Method 600 begins at step 602, where the owner DOM in a source host requests a connection to a component DOM in a destination host. This can be due to object creation or movement of the object from one owner thread to another owner thread. At step 604, the owner DOM passes the owner thread index to the component DOM. The owner thread index is the index of the owner thread to which the object is assigned in the array of owner threads. At step 606, the component DOM looks up the component for the object (e.g., the target of the connection request). At step 608, if the component is found, method 600 proceeds to step 610. At step 608, if the component is not found, method 600 proceeds to step 612.

At step 612, the component DOM creates the component. At step 614, the component DOM assigns the component to a component thread based on the owner thread index. For example, the component DOM can determine the index of the component thread by computing owner thread index modulo the number of component threads. Method 600 then finishes at step 616.

At step 610, since the component has been found, the component DOM extracts the component thread index and compares with the owner thread index (e.g., compares with the result of the owner thread index modulo the number of component threads). If at step 618 they are different, method 600 proceeds to step 620. If at step 618 they are not different, method 600 finishes at step 616. At step 620, component DOM preforms pre-cleanup of the component. The component DOM can quiesce pending operations on the component. At step 622, the component DOM reinitializes the component on the new component thread selected based on the owner thread index. At step 624, the component DOM resynchronizes the component. This is step allows the moving component mentioned above to become offline (following step 620) and lose some writes while keeping the object alive (readable and writable) without being inconsistent or stale if the object has more than one replica. However, after step 622 of re-initialization on the new thread index, the component backing one of its replicas can become stale and reduce the number of faults to tolerate on the object according to the object's storage policy (about how many faults it can tolerate before its data becomes unavailable). After step 624, the object will restore to its original defined fault-to-tolerate and be compliant with its storage policy. Method 600 then finishes at step 616.

An advantage of this coordination of threads is that it is not limited to the use case of owner-component network traversals. In the vSAN DOM's context, the techniques can be extended to the network traversal between clients and owners, such as when clients and owners are on asymmetrical setups where the number of clients and owner threads are different. Furthermore, the techniques can be extended to be used over multiple hops (more than three) if additional roles are created between client-owner or owner-components. Thus, the described techniques are the archetype of thread coordination in a scaling-out cluster workload setting under constrained network resources or the like. The techniques can be used in the communication/traversal pattern between different roles in a large scale cluster/cloud computing system, and not limited to just distributed storage systems described herein.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of coordinating threads executing in a host cluster in a virtualized computing system, the host cluster comprising hosts connected to a network, the method comprising:
assigning objects to owner threads of an owner executing in a first host of the hosts, the objects mapped to virtual resources attached to virtual machines (VMs) executing in the host cluster;
assigning components of the objects to component threads executing in a second host of the hosts based on thread indexes of the owner threads, the component threads managing physical resources backing the virtual resources; and
establishing connections through the network between the owner threads and the component threads.

2. The method of claim 1, wherein the virtual resources are virtual disks, and wherein the physical resources are disk groups, each disk group comprising a plurality of storage devices disposed in the hosts.

3. The method of claim 1, wherein each host of the hosts executes a virtualization layer, wherein the owner threads execute in the virtualization layer of the first host, and wherein the component threads execute in the virtualization layer of the second host.

4. The method of claim 1, wherein the step of assigning the components comprises:
receiving, at an object manager executing in the second host, a connection request from a first owner thread of the owner threads, the connection request identifying a first component of the components and including a first thread index of the first owner thread; and
assigning, in response to the first component being unassigned, the first component to a first component thread of the component threads based on the first thread index.

5. The method of claim 4, wherein a thread index of the first component thread is a result of the first thread index modulo a number of the component threads.

6. The method of claim 1, wherein the step of assigning the components comprises:
receiving, at an object manager executing in the second host, a connection request from a first owner thread of the owner threads, the connection request identifying a first component of the components and including a first thread index of the first owner thread;
determining, in response to identifying a first component thread of the component threads having the first component assigned thereto, that the first component should be moved based on the first thread index; and
moving the first component thread from the first component thread to a second component thread of the component threads, the second component thread selected based on the first thread index.

7. The method of claim 1, wherein, after the assignment of the components to the component threads based on the thread indexes of the owner threads, the connections between the owner threads and the components threads are such that each owner thread is connected to only one of the component threads.

8. A non-transitory computer readable medium comprising instructions to be executed in a computing device to cause the computing device to carry out a method of coordinating threads executing in a host cluster in a virtualized computing system, the host cluster comprising hosts connected to a network, the method comprising:
assigning objects to owner threads of an owner executing in a first host of the hosts, the objects mapped to virtual resources attached to virtual machines (VMs) executing in the host cluster;
assigning components of the objects to component threads executing in a second host of the hosts based on thread indexes of the owner threads, the component threads managing physical resources backing the virtual resources; and
establishing connections through the network between the owner threads and the component threads.

9. The non-transitory computer readable medium of claim 8, wherein the virtual resources are virtual disks, and wherein the physical resources are disk groups, each disk group comprising a plurality of storage devices disposed in the hosts.

10. The non-transitory computer readable medium of claim 8, wherein each host of the hosts executes a virtualization layer, wherein the owner threads execute in the virtualization layer of the first host, and wherein the component threads execute in the virtualization layer of the second host.

11. The non-transitory computer readable medium of claim 8, wherein the step of assigning the components comprises:
receiving, at an object manager executing in the second host, a connection request from a first owner thread of the owner threads, the connection request identifying a first component of the components and including a first thread index of the first owner thread; and
assigning, in response to the first component being unassigned, the first component to a first component thread of the component threads based on the first thread index.

12. The non-transitory computer readable medium of claim 11, wherein a thread index of the first component thread is a result of the first thread index modulo a number of the component threads.

13. The non-transitory computer readable medium of claim 8, wherein the step of assigning the components comprises:
receiving, at an object manager executing in the second host, a connection request from a first owner thread of the owner threads, the connection request identifying a first component of the components and including a first thread index of the first owner thread;
determining, in response to identifying a first component thread of the component threads having the first component assigned thereto, that the first component should be moved based on the first thread index; and
moving the first component thread from the first component thread to a second component thread of the component threads, the second component thread selected based on the first thread index.

14. The non-transitory computer readable medium of claim 8, wherein, after the assignment of the components to the component threads based on the thread indexes of the owner threads, the connections between the owner threads and the components threads are such that each owner thread is connected to only one of the component threads.

15. A virtualized computing system having a host cluster comprising hosts connected to a network, the virtualized computing system comprising:
a first host of the hosts configured to execute a first object manager, the first object manager configured to assign objects to owner threads of an owner executing in a first host, the objects mapped to virtual resources attached to virtual machines (VMs) executing in the host cluster; and
a second host of the hosts configured to execute a second object manager, the second object manager configured to assign components of the objects to component threads executing in the second host based on thread indexes of the owner threads, the component threads managing physical resources backing the virtual resources;
wherein the owner threads are configured to establish connections through the network with the component threads.

16. The virtualized computing system of claim 15, wherein the virtual resources are virtual disks, and wherein the physical resources are disk groups, each disk group comprising a plurality of storage devices disposed in the hosts.

17. The virtualized computing system of claim 15, wherein each host of the hosts executes a virtualization layer, wherein the owner threads execute in the virtualization layer of the first host, and wherein the component threads execute in the virtualization layer of the second host.

18. The virtualized computing system of claim 15, wherein the second object manager is configured to assign the components by:
Receiving a connection request from a first owner thread of the owner threads, the connection request identifying a first component of the components and including a first thread index of the first owner thread; and
assigning, in response to the first component being unassigned, the first component to a first component thread of the component threads based on the first thread index.

19. The virtualized computing system of claim 15, wherein the second object manager is configured to assign the components by:
receiving a connection request from a first owner thread of the owner threads, the connection request identifying a first component of the components and including a first thread index of the first owner thread;
determining, in response to identifying a first component thread of the component threads having the first component assigned thereto, that the first component should be moved based on the first thread index; and
moving the first component thread from the first component thread to a second component thread of the component threads, the second component thread selected based on the first thread index.

20. The virtualized computing system of claim 15, wherein, after the assignment of the components to the component threads based on the thread indexes of the owner threads, the connections between the owner threads and the components threads are such that each owner thread is connected to only one of the component threads.
